(19) United States
(12) Patent Application Publication
(10) Pub. No.: US 2025/0297466 A1
(43) Pub. Date: Sep. 25, 2025

(54) Beverage Machine with Integrated Air-to-Water Generation System

(71) Applicant: Kara Water, Inc., New York, NY (US)

(72) Inventors: Cody Soodeen, Stroudsburg, PA (US); Colin Paterson, Carlisle, MA (US); William Irvine, Riverside, CT (US)

(73) Assignee: Kara Water, Inc., New York, NY (US)

(21) Appl. No.: 19/087,349

(22) Filed: Mar. 21, 2025

Related U.S. Application Data
(60) Provisional application No. 63/568,963, filed on Mar. 22, 2024.

(51) Int. Cl. E03B 3/28; B67D 1/00

(52) U.S. Cl. CPC E03B 3/28; B67D 1/0016; B67D 1/0078; B67D 2210/00015; B67D 2210/00128

(57) ABSTRACT

The beverage machine may comprise a housing assembly, a water generation assembly, a water storage assembly, and a beverage generation assembly. The water generation assembly may be positioned within the housing assembly and is designed to extract water from the air. In preferred embodiments, the water generation assembly comprises a desiccant system designed to extract moisture from the air and convert it into water using a desiccant. The process typically involves pulling air into the system, where it comes into contact with a desiccant that attracts the moisture. This moisture-laden desiccant is then heated, releasing the water vapor, which is subsequently condensed into liquid water and collected. The water storage assembly is mounted to the housing assembly and is adapted to store and sanitize the water collected by the water generation assembly. The beverage generation assembly utilizes the sanitized water stored in the water storage assembly to produce beverages.

### CROSS-REFERENCE TO RELATED APPLICATION

This application claims priority to U.S. Provisional Application No. 63/568,963, filed on Mar. 22, 2024, which is incorporated herein by reference in its entirety.

### BACKGROUND

Beverage machines have garnered widespread popularity globally, offering a convenient solution for enjoying a variety of beverages. Water oftentimes is a critical ingredient. Conventional beverage machines, such as coffee makers, typically utilize tap water or bottled water for the brewing process. However, both water sources may introduce contaminants into the brewed beverage. In the United States and abroad, the quality of tap water can vary significantly depending on geographical location, the source of the water, and the effectiveness of local water treatment facilities. Despite regulations and efforts to ensure safe drinking water, some contaminants can still be present in tap water. These contaminants can come from natural sources, industrial processes, agricultural activities, and urban runoff. Known contaminants include microorganisms such as bacteria, viruses, and parasites, chemicals such as chlorine and pesticides, and industrial pollutants such as volatile organic compounds (VOCs) and microplastics. Meanwhile, plastic water bottles can leach various chemicals into the water they contain, especially under certain conditions like exposure to heat, sunlight, or if the bottles are old or reused.

A need exists for a beverage machine capable of creating beverages using a cleaner water source.

### SUMMARY

The invention disclosed herein is directed to a beverage machine with an integrated air-to-water generation system. Because air-to-water generation systems are capable of generating the purest forms of water, the beverage machine of the present invention is capable of producing beverages free from the typical contaminants found in tap and bottled water. The beverage machine of the present invention is also capable of providing water for beverage production in environments where access to traditional water sources is limited.

In an embodiment exemplifying the principles of the invention, the beverage machine may comprise a housing assembly, a water generation assembly, a water storage assembly, and a beverage generation assembly. The water generation assembly may be positioned within the housing assembly and is designed to extract water from the air. In preferred embodiments, the water generation assembly comprises a desiccant water generator system designed to extract moisture from the air and convert it into water using a desiccant. Desiccants are substances that naturally attract moisture from the air due to their hygroscopic properties. The process typically involves pulling air into the system, where it comes into contact with a desiccant that attracts the moisture. This moisture-laden desiccant is then heated, releasing the water vapor, which is subsequently condensed into liquid water and collected. The water storage assembly is mounted to the housing assembly and is adapted to store and sanitize the water collected by the water generation assembly. The beverage generation assembly is adapted to utilize the sanitized water stored in the water storage assembly to produce beverages.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages in accordance with the present invention:

FIG. 1 is a perspective view of an embodiment of a portable beverage machine exemplifying the principles of the present invention;

FIG. 2 is an exploded view of the portable beverage machine of FIG. 1;

FIG. 3A is an exploded view of the housing assembly of the portable beverage machine of FIG. 1;

FIG. 3B is an exploded view of the front housing of the of the portable beverage machine of FIG. 1;

FIG. 3C is two cross-sectional views of the cup lift mechanism of the portable beverage machine of FIG. 1;

FIG. 4A is a perspective view of the air-to-water generation assembly of the portable beverage machine of FIG. 1;

FIG. 4B is an exploded view of the air-to-water generation assembly of the portable beverage machine of FIG. 1;

FIG. 4C is an exploded view of the air-to-water generation assembly of the portable beverage machine of FIG. 1;

FIG. 4D is a perspective view of an exemplary embodiment of an air duct that may be used in the air-to-water generation assembly of the portable beverage machine of FIG. 1;

FIG. 4E is a perspective view of an exemplary embodiment of an air duct that may be used in the air-to-water generation assembly of the portable beverage machine of FIG. 1;

FIG. 5A is an exploded view of the water storage assembly of the portable beverage machine of FIG. 1;

FIG. 5B is a perspective view of the water storage assembly of the portable beverage machine of FIG. 1;

FIG. 5C is a top view of the components that pass through the bottom of water tank and the horizontal panel of the rear housing of the portable beverage machine of FIG. 1;

FIG. 5D is a perspective view of the horizontal panel of the rear housing of the beverage generation assembly of the portable beverage machine of FIG. 1;

FIG. 5E is an exploded view of the UV sanitization subassembly of the beverage generation assembly of the portable beverage machine of FIG. 1;

FIG. 6A is a perspective view of the heater subassembly of the beverage generation assembly of the portable beverage machine of FIG. 1;

FIG. 6B is an exploded view of the heater subassembly of the portable beverage machine of FIG. 1;

FIG. 7A is a rear view of an embodiment of the pod subassembly of the portable beverage machine of FIG. 1;

FIG. 7B is a side view of the embodiment of the pod subassembly of FIG. 7A;

FIG. 7C is a bottom-perspective, exploded view of the embodiment of the pod subassembly of FIG. 7A;

FIG. 7D is a top-perspective, exploded view of the embodiment of the pod subassembly of FIG. 7A;

FIG. 8A is a perspective view of an alternative embodiment of the pod subassembly of the portable beverage machine of FIG. 1; and

FIG. 8B is an exploded view of the alternative embodiment of the pod subassembly of FIG. 8A.

### DETAILED DESCRIPTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

“Vertical” or “vertical direction” as used herein means a direction that is generally parallel to Earth's gravitational force. “Horizontal” or “horizontal direction” as used herein means a direction that is generally perpendicular to Earth's gravitational force. As used herein, “generally perpendicular” means forming an angle between 85 degrees and 95 degrees.

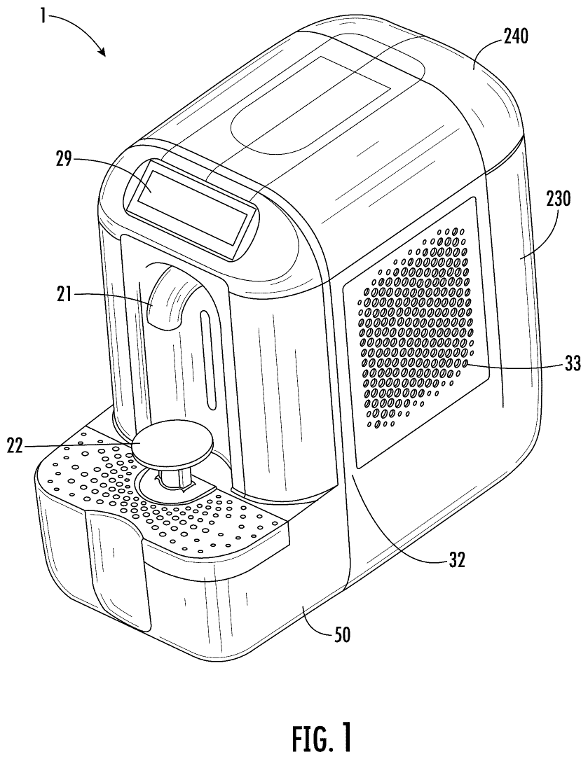

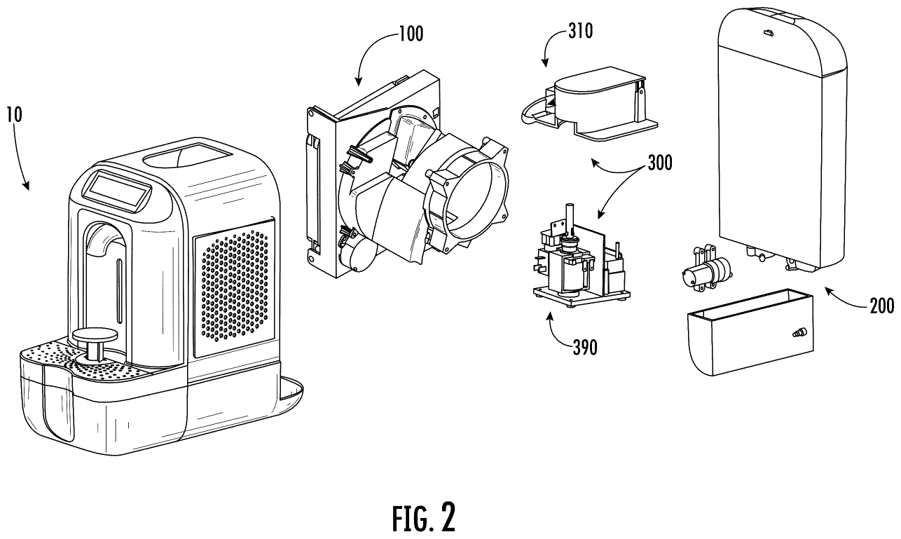

Referring now to FIGS. 1-8B, a portable beverage machine embodying features of the present invention is shown. As shown in FIGS. 1-2, the portable beverage machine 1 may comprise: (1) a housing assembly 10; (2) a water generation assembly 100 positioned within the housing assembly 10 and designed to extract water from the air; (3) a water storage assembly 200 mounted to the housing assembly 10 for storing and sanitizing the water collected by the water generation assembly 100; and (4) a beverage generation assembly 300 positioned within the housing assembly and adapted to utilize the sanitized water stored in the water storage assembly 200 to produce beverages.

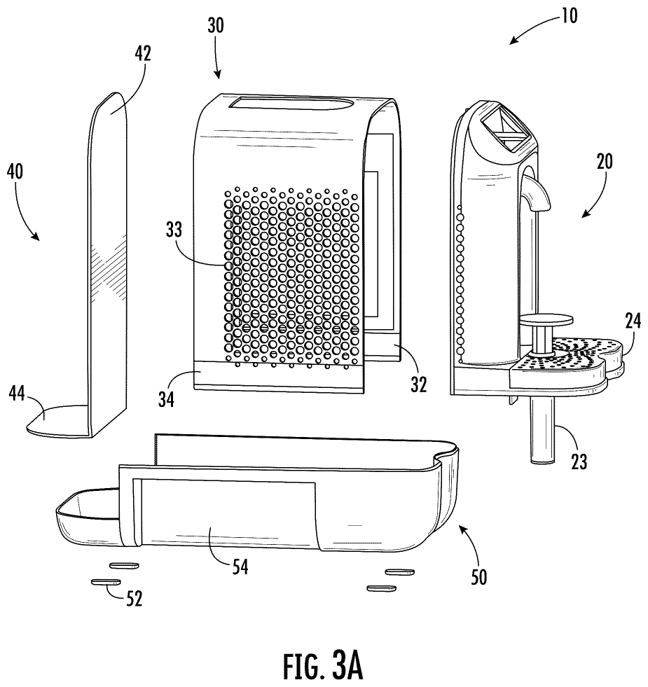

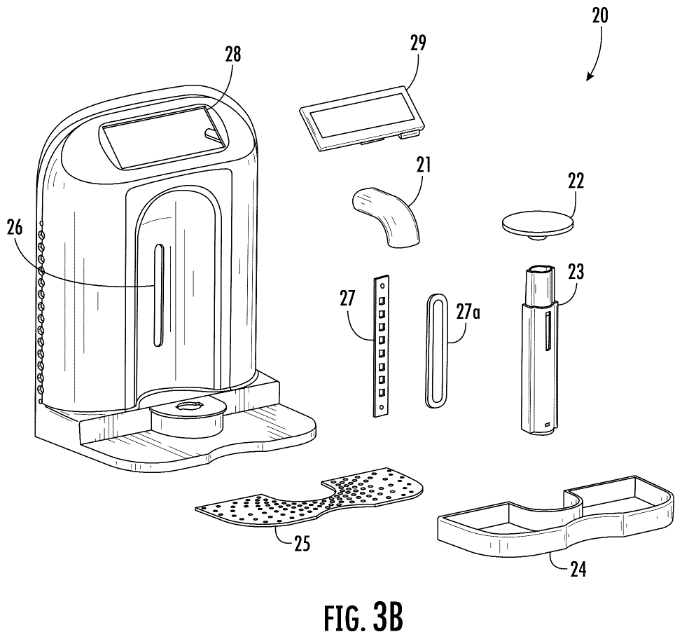

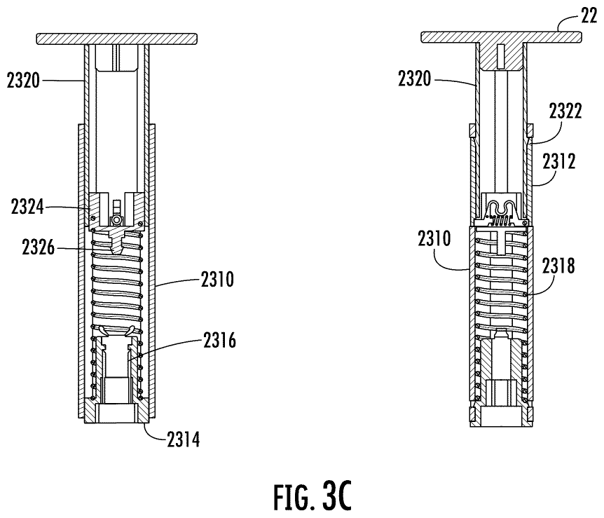

Referring to FIGS. 3A-3C, an embodiment of the housing assembly 10 is shown. In the depicted embodiment, the housing assembly 10 comprises a front housing 20, a central shell 30, a rear housing 40, and a bottom housing 50. The central shell 30 of portable beverage machine 1 features right and left side housing panels 32, 34 having airflow apertures 33 to enable air flow into and out of the water generation assembly 100. Rear housing 40 comprises a vertical panel 42 that separates the central shell 30 from the water storage tank 230 and a horizontal panel 44 that separates the bottom housing 50 from the water storage tank 230. The vertical panel 42 may comprise hooks or any other suitable mechanism designed for releasable connection to water storage tank 230. Bottom housing 50 generally comprises a hollow shell. One side of bottom housing 50 includes a slot 54 for a filter chamber 210 (discussed below) to fit. The underside of bottom housing 50 comprises non-slip mats 52 designed to contact the countertop or other surface to prevent the portable beverage machine 1 from slipping.

Turning to FIG. 3B, front housing 20 comprises a spout 21 through which the freshly brewed beverage is poured, a cup plate 22 on which the user can place a cup to receive the beverage poured from the spout 21, a cup plate lift mechanism 23 that allows for adjustment of the height of the cup plate 22 depending on the size of the cup being used, a drip tray 24 surrounding cup plate 22, and a grate 25 covering drip tray 24. The cup plate lift mechanism 23 may be a spring-loaded press-release mechanism. As shown in FIG. 3C, the cup plate lift mechanism 23 of the depicted embodiment comprises an outer tube 2310 and an inner tube 2320 slidably sheathed within the outer tube 2310. The outer tube 2310 comprises a base component 2314 which includes a lock button 2316. The inner tube 2320 comprises a base component 2324 which includes a lock flange 2326 protruding downward towards the lock button 2316. A spring 2318 is situated between the base component 2314 and the base component 2324. To shift the cup plate lift mechanism 23 to the lowered position, the user simply pushes down on the cup plate 22, thereby compressing spring 2318 until the lock flange 2326 enters the lock button 2316 and clicks into place. To shift the cup plate lift mechanism 23 back to the raised position, the user simply pushes down again on the cup plate 22 until the lock button 2316 releases, and the spring 2318 will naturally push inner tube 2320 back outward. Outer tube 2310 comprises grooves 2312 through which tabs 2322 on inner tube 2320 protrude to prevent spring 2318 from pushing inner tube 2320 entirely out of outer tube 2310 when in the raised position.

The functionality of the portable beverage machine 1 is managed by a central control panel (not pictured) coupled to one or more printed circuit boards (PCBs) storing programming modules that allow a user to control functions typically associated with conventional portable beverage machines, such as the ability to turn the portable beverage machine on and off, set the brew strength, program brewing schedules, etc. For example, in some embodiments, portable beverage machine 1 may utilize an LCD control touch screen 29 connected to a screen controller PCB for user input. The LCD control touch screen 29 is visible through window 28 in front housing 20. Additionally, some embodiments of portable beverage machine 1 may feature an LED PCB 27 with indicator lights, protected by a transparent cover 27a and visible through an opening 26 in front housing 20. These control elements are merely exemplary of the many elements of a control system that a skilled artisan would readily recognize as being useful in portable beverage machine 1.

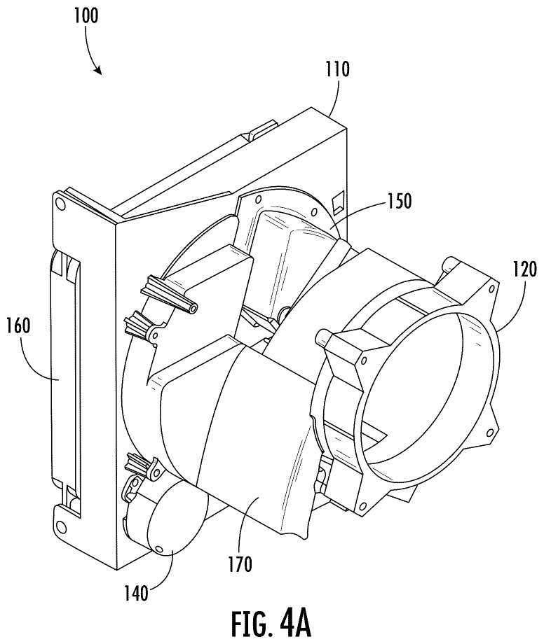

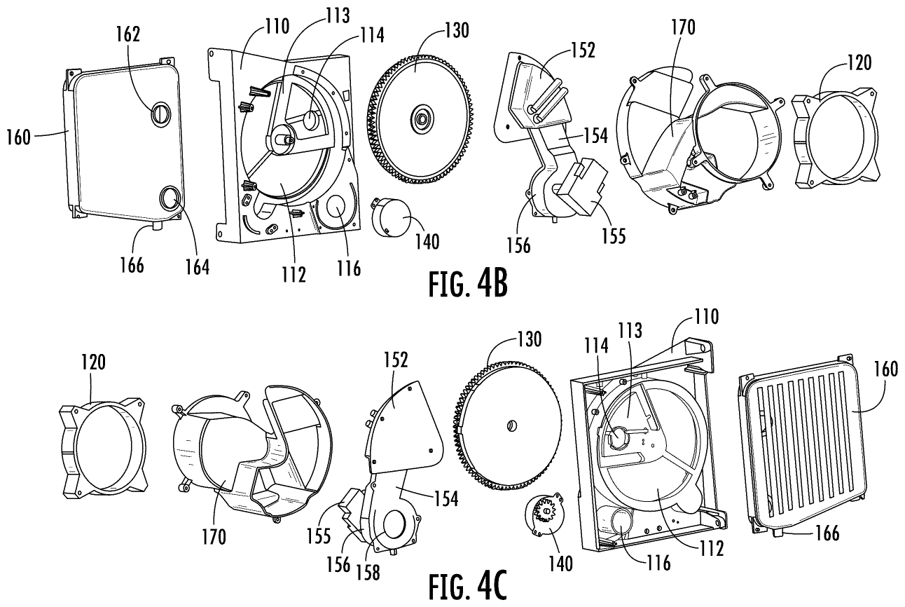

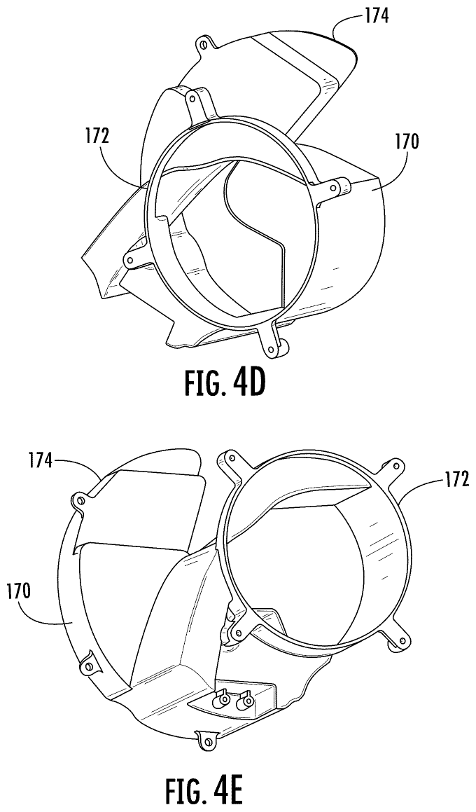

Referring now to FIGS. 4A-4E, the water generation assembly 100 may comprise: a frame 110, a fan 120, a desiccant wheel 130, a motor 140, a heater 150, a water condenser tank 160, and an air duct 170. The desiccant wheel 130 is coated or compounded with a desiccant, which can be Zeolite, silica gel, or any other hygroscopic substance that has a high affinity for water molecules. The fan 120 preferably is a lateral fan powered by a fan motor (not pictured). When the device 1 is turned on, the lateral fan 120 pulls air from the atmosphere into air duct 170, which directs the air through the water generation assembly 100. Air duct 170 has a first end 172 which mates with fan 120 and a second end 174 which aligns with the frame 110 to cover the process region of the wheel 130 (see discussion of regeneration region and process region below). While typical portable desiccant systems use rotor fans that exhaust the dehumidified air out the top of the system, the water generation assembly 100 of the present invention has been adapted to employ a lateral fan 120 so that the air travels in a horizontal path (relative to the ground) through the portable beverage machine 1. This allows the portable beverage machine 1 to be built with the pod subassembly 310 on top of the machine so that the prepared beverage can drip from the pod subassembly 310 into the user's cup below.

The frame 110 comprises a desiccant wheel chamber 111, which includes a covered portion 113, an uncovered portion 112, and a first aperture 114 situated in the covered portion 113 of the desiccant wheel chamber 111; a motor chamber 118; and a second aperture 116 positioned below the wheel chamber 111. When the desiccant wheel 130 is situated within the wheel chamber 111, the wheel 130 is rotated by motor 140, which is situated in the motor chamber 118. The covered portion 113 of the wheel chamber 111 shields approximately one-third of the desiccant wheel 130 as it rotates within the wheel chamber 111. On the opposite side of the frame 110 and desiccant wheel 130, the heating element 152 of the heater unit 150 aligns with the covered portion 113 of the wheel frame 110. The region of the desiccant wheel 130 situated in between the covered portion 113 and heater unit 150 at any given moment is the regeneration region. The remaining portion of the desiccant wheel is the process region—or moisture-attracting region of the wheel.

In addition to its heating element 152, the heater unit 150 also comprises a heater fan 156 situated inside a duct 154 that connects the heater fan 156 to the heating element 152. The duct 154 comprises a heater inlet 158 over the fan that aligns with the second aperture 116 of the frame 110 when installed. The heater unit 150 also comprises an electric motor 155, which powers the heating element 152. On the opposite side of the frame 110, the water condenser tank 160 is a hollow body that comprises an air inlet 162 that aligns with the first aperture 114 of the frame 110, an air outlet 164 that aligns with the second aperture 116 of the frame 110, and a water outlet 166 situated in the bottom face of the water condenser tank 160.

The working principle of the water generation assembly 100 is described below. The fan 120 pulls exterior airflow through the airflow apertures 33 in the right side housing 32 of the shell 30 and into the water generation assembly 100. The exterior air passes the exterior of the water condenser tank 160, through the uncovered portion 112 of the desiccant wheel chamber 111 of frame 110, and then through the process region of the desiccant wheel 130, where the desiccant material of the wheel 130 captures the water vapor as the air passes through the wheel 130. Once through the wheel 130, the dehumidified air passes through the apertures 128 of fan cover 126, then through the lateral flow of the lateral fan 120, before it is finally exhausted out through the airflow apertures 33 in the left side housing 34 of the shell 30.

Meanwhile, a second, internal airflow is circulated through the system 100. The heater fan 156 drives the internal airflow through the heating element 152, then through the regeneration region of the desiccant wheel 130, where the warm air heats the water captured by the desiccant wheel 130 to the point of vaporization. The humidified air then flows through the first aperture 114 of frame 110 and into air inlet 162 of the water condenser tank 160. In the water condenser tank 160, the humid internal air is cooled by the exterior airflow being pulled past the exterior of the water condenser tank 160 by the lateral fan 120, causing the water vapor in the humidified air to condense inside the water condenser tank 160. The water then pours out of the water outlet 166 into the filter chamber 210 below. As the cool, dehumidified air naturally falls to the bottom of the water condenser tank 160, it is pulled out by the heater fan 156 through the air outlet 164 of the water condenser tank 160, through the second aperture 116 of the frame 110, and back through the heater inlet 158 into the duct 154 of the heater unit 150, where it is recycled through the heating element 152 to become warm airflow for regenerating the desiccant wheel 130. Because the wheel 130 is constantly rotated by the motor 140 while desiccant wheel assembly 100 is producing water, a saturated portion of the wheel 130 is always entering the regeneration region, where it is dried and then rotated out of the regeneration region and back into the process region, ready to capture more water from the incoming ambient air again. The desiccant system described above is merely exemplary of the wide variety of water generation systems, both known in the art or developed in the future, that may be employed in the portable beverage machine 1 of the present invention.

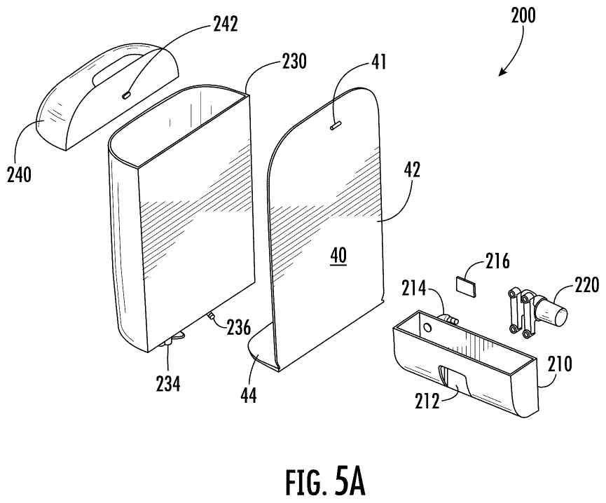

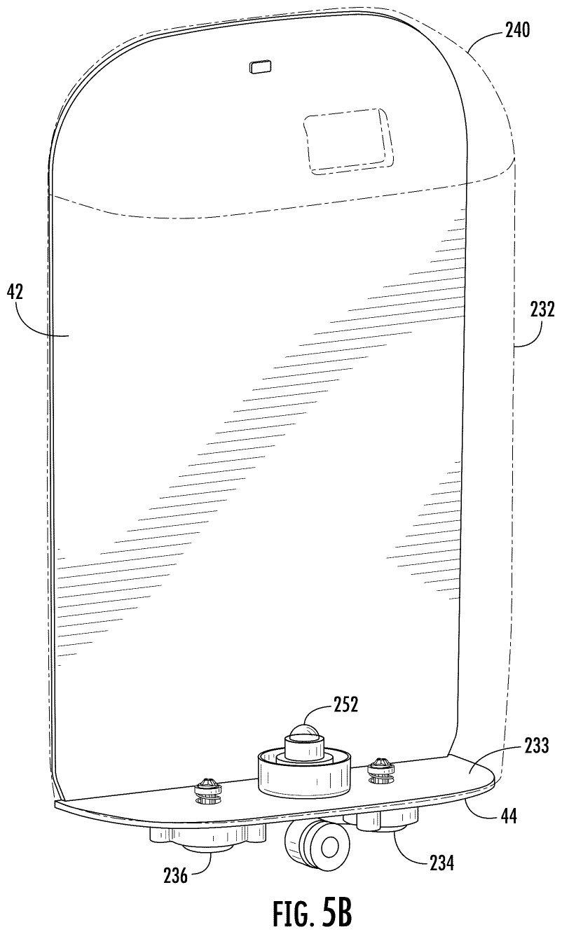

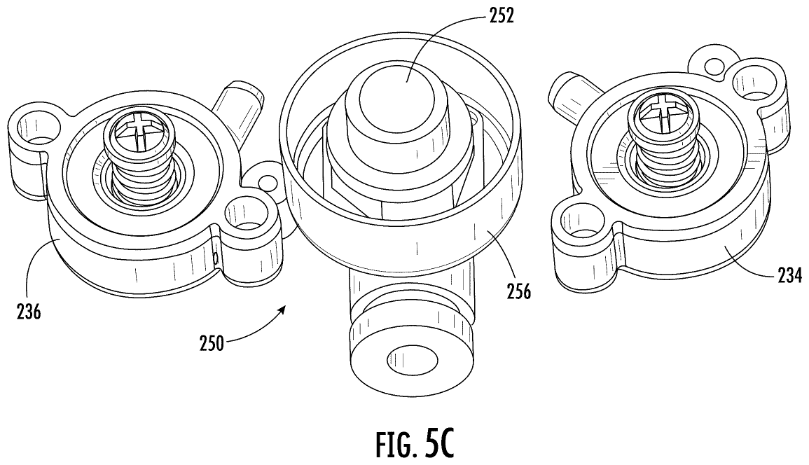

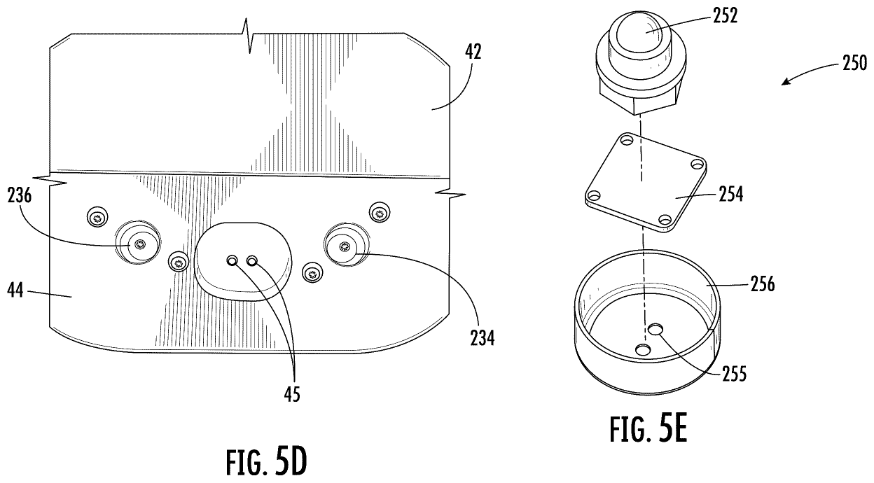

Turning now to FIGS. 5A-5C the generated water next enters the water storage assembly 200. After the water condenses in the water condenser tank 160, it exits through water outlet 166 and enters filter chamber 210, which comprises one or more filters that remove any particulates or contaminants in the water. The filters may be carbon filters, mineralization filters, or any other high-filtration components. The filter chamber 210 comprises a handle 212 that allows the user to easily remove the filter chamber 210 from the slot 54 in bottom housing 50 to clean and replace the filters. The filter chamber 210 may have a water level sensor 216 operatively connected to the control panel such that when the sensor 216 detects that the filter chamber 210 is full, the control panel automatically prompts water pump 220 to pump the filtered water from the outlet 214 of filter chamber 210 into storage tank 230 through inlet valve 234.

Storage tank 230 may comprise a tank body 232, a bottom plate 233, and a lid 240. Underneath bottom plate 233 are two valves that extend into bottom housing 50: an inlet valve 234, through which water enters storage tank 230 from filter chamber 210; and an outlet valve 236, through which water exits storage tank 230 to make a beverage at beverage generation assembly 300. In some embodiments, the tank 230 may be connected to a second outlet valve, through which water exists storage tank 230 and is carried directly to spout 11. In this embodiment, the spout 11 comprises two separate channels—one for pure water and one for beverages generated in the generation assembly 300. The back of tank body 232 comprises pockets 231 which slide around hooks 43 of rear housing 40 to lock the storage tank 230 into place. Once storage tank 230 is seated on rear housing 40, removable lid 240 may be placed on top of tank body 232. The lid 240 includes sensors that detect when the lid 240 is seated properly on the tank body 232. For example, the depicted embodiment comprises a magnet 242 on tank lid 240 that engages a magnet sensor 41 positioned on the horizontal panel 44 of rear housing 40, but a skilled artisan would recognize that this is merely illustrative of the many sensor systems that are suitable for this purpose. Inside storage tank 230 is a water level sensor 238, which detects the level of water in the tank 230 and may report the level to the user via LED PCB 27 or via LCD touch screen 29. If the tank is full, the control panel automatically shuts down the water generation assembly 100 so that storage tank 230 does not overflow.

The water storage assembly 200 further comprises a sanitization subassembly 250 that sanitizes the water while it is stored in the storage tank 230. In the exemplary embodiment depicted in the Figures, the sanitation subassembly comprises a UV water treatment system, but a skilled artisan will recognize that this is just one of many sanitization systems that may be employed in the present invention. A UV LED lamp 252 is positioned within tank 230 and is seated on UV lamp adapter PCB 254 positioned beneath the tank bottom plate 233. The UV lamp adapter PCB 254 is covered by a plastic cap 256 that has two gaps 255 leaves only the minimum contact points visible (not pictured). When the tank 230 is properly seated on the rear housing 40, the contact points on the UV lamp adapter PCB 254 touch spring-loaded contact prongs 45 protruding from a control PCB (not pictured) positioned within the bottom housing 50 beneath the tank 230. Once the control PCB registers the tank's 230 placement, the UV LED lamp 252 is automatically activated according to an algorithm, which only allows the UV LED to turn on when the tank 230 is in place and the lid 240 is secured on top so as not to expose the user to UV light. The tank body 232 and lid 240 are formed of opaque material, both to protect the user from exposure to UV light and to protect the stored water from exposure to external light sources that can reactivate any biological contaminants that were neutralized by the UV light. In some embodiments, the control panel may direct a signal either to the LED PCB 27 or to the LCD control touch screen 29 when it registers that the water in the tank has been adequately sanitized based on input from the water level sensor 239 and magnet sensor 41.

After the generated water has been filtered and sanitized, it must pass through the beverage generation assembly 300 when the user prompts machine 1 to prepare a beverage.

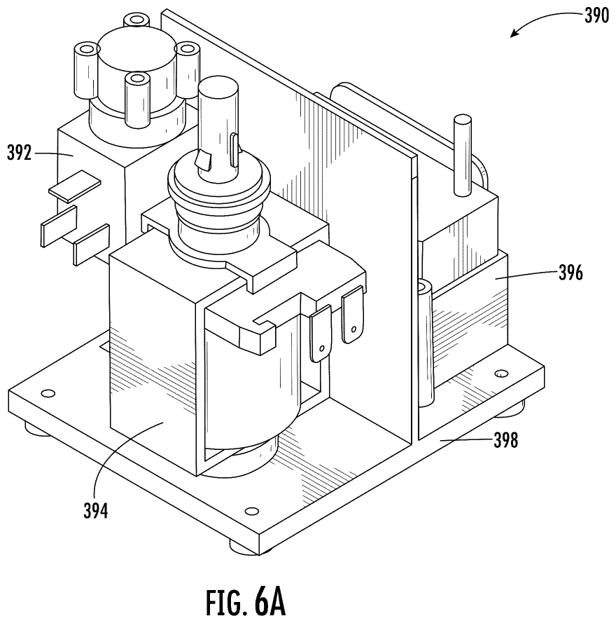

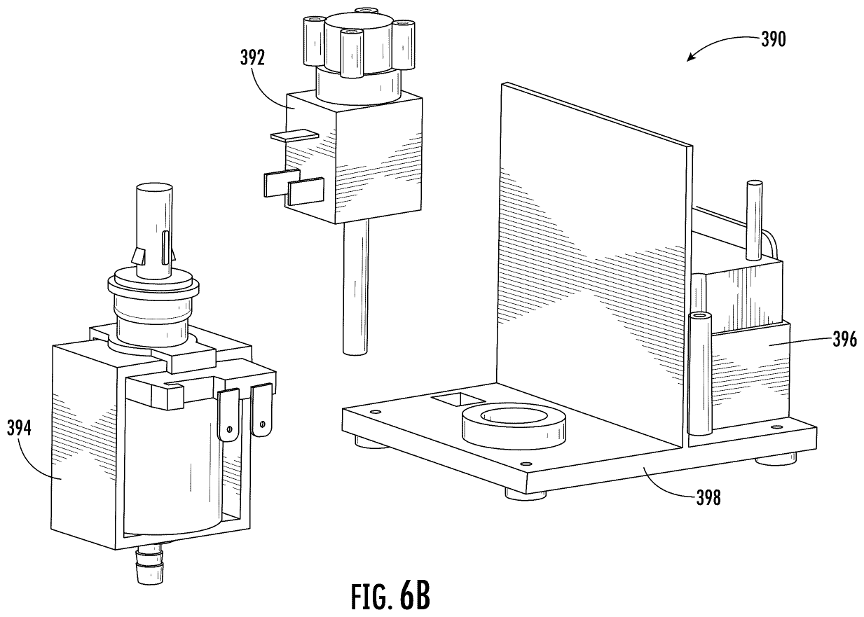

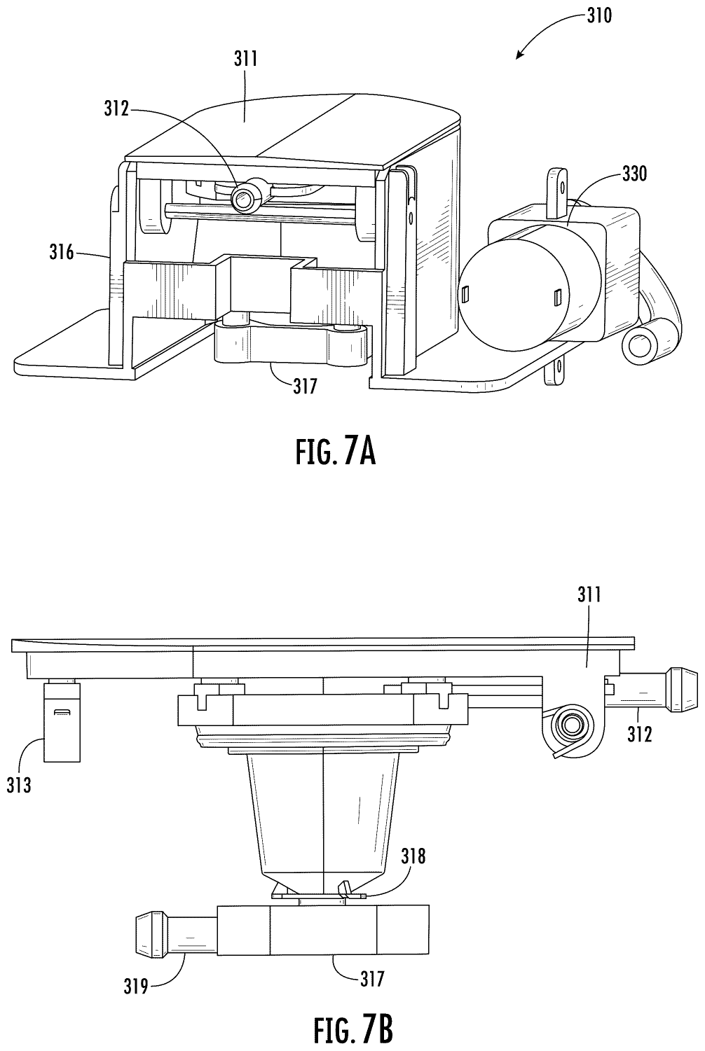

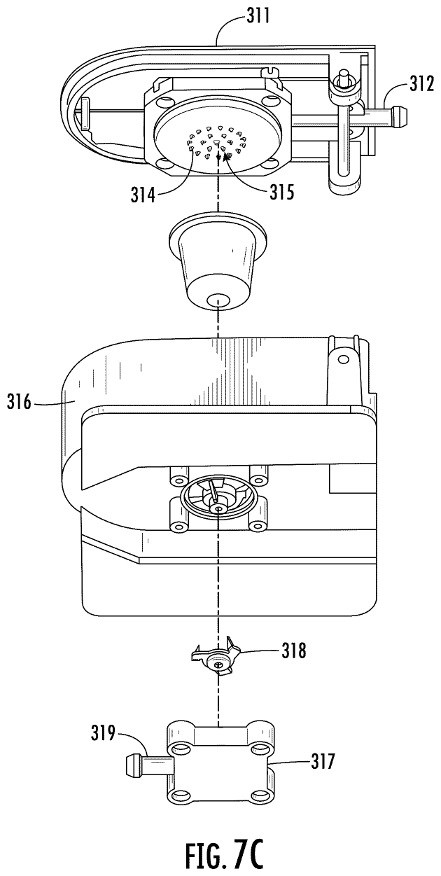

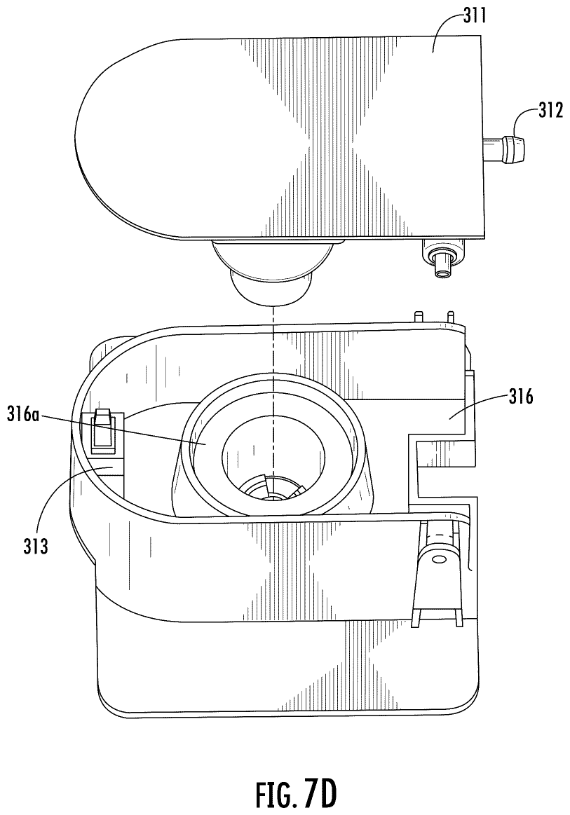

Turning to FIGS. 6A-8B, beverage generation assembly 300 may comprise a pod subassembly 310 and a heater subassembly 390. An exemplary embodiment of pod subassembly 310 is shown in FIGS. 7A-7B. The pod subassembly 310 comprises a pod vehicle 316, a lid 311 operably connected to the pod vehicle 316 using a hinge connection, and a beverage collection basin 317. To insert a pod, the user presses down on the lid 311, which releases the lock by a push-down spring mechanism 313 and allows the lid 311 to raise, exposing the pod vehicle 316 underneath. The user can then insert the pod into the pod compartment 316a, shaped to correspond to a standard beverage pod, in the pod vehicle 316. When the lid 311 is pushed closed, the pod is forced down onto the puncture prongs 318, which puncture the bottom of the pod. At the same time, the aluminum or paper top of the pod is punctured by spikes 314 on the underside of the lid 311, exposing the flavor contents inside the pod. The lid 311 also comprises a water inlet 312 that directs water sent via pump 330 from the heater subassembly 390 through apertures 315 that correspond in location to the spikes 314 such that the water flows through the puncture holes in the top of the pod. The beverage collection basin 317 positioned at the bottom of the pod vehicle 316 comprises a water outlet 319 that directs the beverage released from the bottom of the pod out to the spout 11.

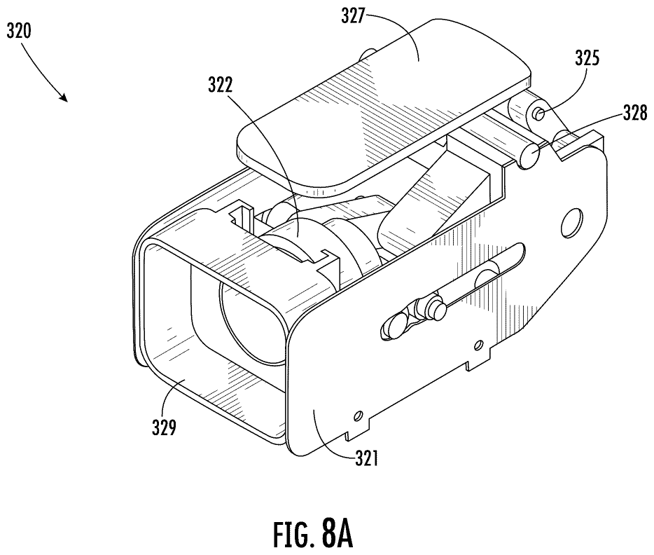

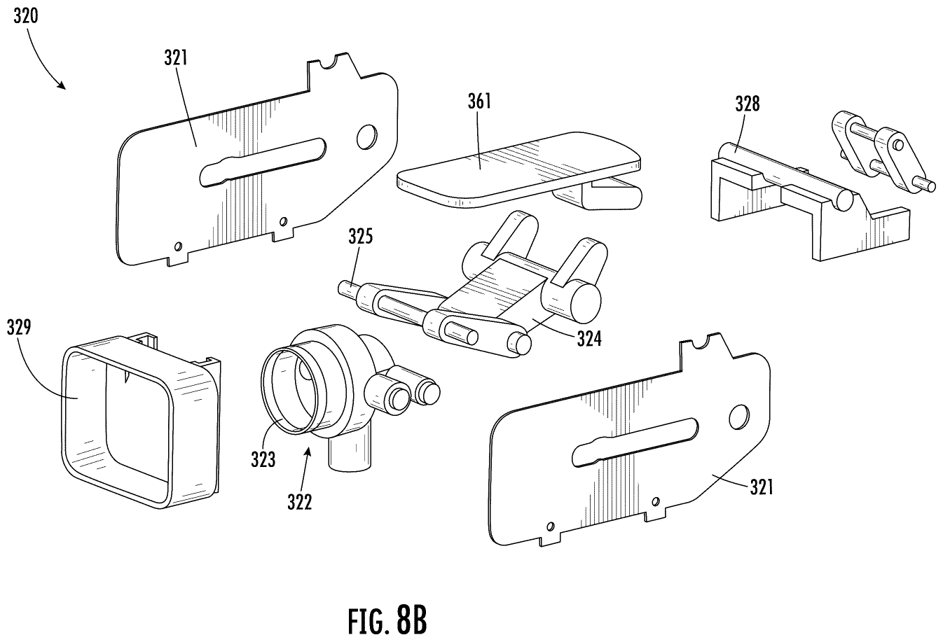

Another exemplary embodiment of a pod subassembly that could be used in portable beverage machine 1 is shown in FIGS. 8A-8B. The alternative pod subassembly 320 comprises two side plates 321, a pod vehicle 322, a hinge system 324, a handle 327, and a water outlet 329. To insert a pod, the user lifts handle 327 upwards, which reveals the internal mechanism of the pod subassembly 320. The handle 327 pivots around rotation pin 328 and pulls handle connection rod 325 of the hinge system 324. In response, the hinge system 324 then pulls the pod vehicle 322 backwards out of water outlet 329, revealing the pod compartment 323 for the user to insert the pod. When the handle 327 is returned to resting position, the pod vehicle 322 is pushed forwards into the water outlet 329, and the handle 327 again covers the internal mechanism of the pod subassembly 320. These two pod assemblies are merely exemplary of the many different configurations of pod assemblies, both known in the art and developed in the future, that can be used in the portable beverage machine 1 of the present invention. In addition, the water generation, purification, and storage systems of the present invention may be incorporated into traditional drip coffee makers, or any other device that produces liquid-based consumables.

When the user initiates the brewing process after inserting a pod into the pod subassembly, water is pumped from storage tank 230 through heater subassembly 390 up to pod subassembly 305. Heater subassembly 390 is depicted in FIGS. 6A-6B and can comprise a frame block 398 that seats a water heater 396, a high-pressure pump 394, and a water valve switch 392. After it has been heated in the heater subassembly 390, the hot water is forced through the pod under pressure in the pod subassembly 305. The portable beverage machine 1 optimizes the water temperature and pressure depending on the beverage being produced and the preferences input by the user. As the hot water passes through the pod, it dissolves and extracts the soluble compounds from the pod contents. Viewing FIGS. 3A-3B, the beverage exits through spout 11 in front housing 20 and is poured into the waiting cup sitting on cup plate 12 below. In some embodiments, after the beverage has been poured, the empty pod may be discarded through a used pod duct into a used pod receptacle. The used pod receptacle may be removable and comprise an external handle so that the user may access the receptacle when it is full and remove the used pods. However, in the depicted embodiment, the used pod duct and receptacle are eliminated so as to improve the lateral air flow of the water generation assembly 100.

Although certain detailed embodiments are disclosed above, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting, but rather, to provide an understandable description of the invention. While the specification concludes with claims defining the features of the invention that are regarded as novel, it is believed that the invention will be better understood from a consideration of the forgoing description in conjunction with the drawing figures, in which like reference numerals are carried forward.

What is claimed is:

1. A portable beverage machine comprising:
a) a housing assembly;
b) an air-to-water generation assembly positioned within the housing assembly;
c) a water storage assembly mounted to the housing assembly configured to store and sanitize the water collected by the water generation assembly; and
d) a beverage generation assembly positioned within the housing assembly and adapted to utilize the sanitized water stored in the water storage assembly to produce beverages.

2. The portable beverage machine of claim 1, wherein the air-to-water generation assembly comprises:
a) a frame;
b) a desiccant wheel mounted to the frame for adsorbing water from ambient air;
c) a heater unit positioned adjacent to a regeneration section of the desiccant wheel;
d) a water condenser tank connected to the frame for collecting condensed water.

3. The portable beverage machine of claim 2, wherein the air-to-water generation assembly further comprises a motor secured to the frame and configured to rotate the desiccant wheel.

4. The portable beverage machine of claim 3, wherein the air-to-water generation assembly further comprises an air duct with a first end and a second end.

5. The portable beverage machine of claim 4, wherein the air-to-water generation assembly further comprises a lateral fan operatively coupled to the air duct.

6. The portable beverage machine of claims 5, wherein a second end of the air duct is secured to the frame and designed to direct ambient air through a process section of the desiccant wheel.

7. The portable beverage machine as in one of claims 2, wherein the heater unit is secured to the frame and comprises: (i) a heating element; and (ii) a heater duct operatively coupling the heating element to regeneration section of the desiccant wheel.

8. The portable beverage machine as in one of claims 2, wherein the water condenser tank comprises an inlet configured to intake exhaust air from the regeneration section of the desiccant wheel.

9. The portable beverage machine of claim 1, wherein the water storage assembly comprises:
a) a filter chamber configured to filter impurities from condensed water received from the air-to-water generation assembly, wherein the filter chamber comprises an outlet;
b) a storage tank, wherein the storage tank comprises and inlet and outlet; and
c) a pump for transmitting water from the filter chamber outlet to the storage tank inlet.

10. The portable beverage machine of claim 9, wherein the water storage assembly further comprises a water sanitization subassembly.

11. The portable beverage machine of claim 10, wherein the water sanitization subassembly comprises a UV light positioned within the storage tank and operatively connected to a printer circuit board (PCB); wherein the PCB, when the tank is mounted on the housing assembly, is configured to operatively connect to a control panel positioned within the housing assembly.

12. The portable beverage machine of claim 9, wherein the water storage assembly further comprises a lid for the storage tank; wherein the lid comprises a magnet that corresponds to a sensor on the housing assembly; wherein the sensor is operatively connected to a control panel positioned within the housing assembly; wherein the control panel is configured not to allow the UV light to turn on unless the PCB is operatively connected to the control panel and the magnet is operatively connected to the sensor.

13. The portable beverage machine of claim 1, wherein the beverage generation assembly comprises:
a) a heater subassembly comprising a pump for transmitting water from the water storage assembly to the heater subassembly; and
b) a pod subassembly positioned at the top of the housing assembly.

14. The portable beverage machine of claim 13, wherein the pod subassembly comprises:
a) a pump for transmitting water from the heater subassembly to an inlet of the pod subassembly;
b) a pod compartment configured to receive a beverage pod;
c) at least one puncture element adjacent to the pod compartment; and
d) a beverage collection basin situated beneath the pod compartment and fluidly coupled to an outlet of the pod subassembly.

15. The portable beverage machine of claim 14, wherein the heater subassembly comprises:
i) a frame block;
ii) a water heater connected to the frame block;
iii) a high-pressure pump operatively connected to the water heater; and
iv) a water valve switch operatively connected to the high-pressure pump.
